(19) United States
(12) Patent Application Publication
(10) Pub. No.: US 2007/0088738 A1
(43) Pub. Date: Apr. 19, 2007

(54) Ocean tomo patent concepts

(76) Inventors: Jonathan A. Barney, Newport Beach, CA (US); Lang J. McHardy, San Francisco, CA (US); Phil Hartstein, San Francisco, CA (US); Andrew T. Ramer, Chicago, IL (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/517,070

(22) Filed: Sep. 7, 2006

Related U.S. Application Data
(60) Provisional application No. 60/714,980, filed on Sep. 7, 2005.

(51) Int. Cl. G06F 7/00

(52) U.S. Cl. 707/102

(57) ABSTRACT

Methods for monitoring and measuring the performance of intellectual property (IP) law firms are disclosed. These methods are based on but are not limited to the performance of the firm, its attorneys, its clients, and the trends of this performance over time. The methods disclosed provide IP Law firm with analytics to identify performance and service opportunities for the firm, ultimately resulting in higher revenues.

### CROSS-REFERENCE TO RELATED APPLICATIONS

This application claims the benefit of U.S. Provisional Application No. 60/714,980, filed Sep. 7, 2005, the entirety of which is hereby incorporated by reference.

### BACKGROUND OF THE INVENTION

1. Field of the Invention

The present invention relates to the field of monitoring and measuring the performance of intellectual property law firms.

2. Description of the Related Art

Patents play an important role in the economy, specifically, encouraging private investment in the development of new technologies that improve productivity and quality of life for everyone. Each year more than a quarter-million intellectual property law firm applications are filed in the United States Patent and Trademark Office (“PTO”) resulting annually in the issuance of over a hundred fifty-thousand intellectual property law firms Patent owners and applicants pay combined annual fees and costs of nearly a billion dollars (about $6,700 per issued intellectual property law firm) to the PTO to prosecute and maintain their intellectual property law firms and applications. This does not include the additional fees and costs expended for related professional services, such as attorney's fees and drafting charges.

In addition, each year thousands of intellectual property law firm infringement suits are brought in the federal courts seeking to enforce intellectual property law firm rights. In the 12 months ended Jun. 30, 1992, U.S. federal district courts heard a total of 1407 such intellectual property law firm cases through trial. See V. Savikas, “Survey Lets Judges Render Some Opinions About the Patent Bar,” Nat'l L. J., Jan. 18, 1993, at 57. A recent survey conducted by the American Intellectual Property Law Associations (“AIPLA”) reported that the median cost of intellectual property law firm litigation for each side through trial was about $650,000. AIPLA., “Report of Economic Survey” (1991). Other more recent estimates place the cost of intellectual property law firm enforcement litigation somewhere in the range of about $1 million per side through trial. Thus, the aggregate annual cost for obtaining, maintaining and enforcing intellectual property law firms in the United States is easily in the multiple billions of dollars. Similar costs are incurred by intellectual property law firms in various other foreign countries where intellectual property law firms may be obtained and enforced.

Because of the great importance of intellectual property law firms in the both the U.S. and global economies there has been continued interest in monitoring and measuring the performance of intellectual property law firms in order to better protect intellectual property assets.

### SUMMARY OF THE INVENTION

A computer-automated method for rating or ranking intellectual property law firms or other intangible assets comprising, selecting a first population of intellectual property law firms having a first quality or characteristic; and selecting a second population of intellectual property law firms having a second quality or characteristic that is different from or assumed to be different from said first quality or characteristic; and providing a computer-accessible database of selected intellectual property law firm metrics representative of or describing particular corresponding characteristics of each said intellectual property law firm in said first and second intellectual property law firm populations; and constructing a computer regression model based on said selected intellectual property law firm metrics, said regression model being operable to input said selected intellectual property law firm metrics for each said intellectual property law firm in said first and second intellectual property law firm populations and to output a corresponding rating or ranking that is generally predictive of the presence or absence of said first and/or second quality in said first and second intellectual property law firm populations according to a determined statistical accuracy; and using said regression model to rate or rank one or more intellectual property law firms in a third intellectual property law firm population by inputting into said regression model selected intellectual property law firm metrics representative of or describing corresponding characteristics of said one or more intellectual property law firms in said third population to be rated or ranked and causing said regression model to output a corresponding rating or ranking based thereon.

### DETAILED DESCRIPTION OF THE PREFERRED EMBODIMENT

Law Firm Analytics (“LFA”)—IP Law firms must monitor and measure their own performance. This includes the performance of the firm, its attorneys, its clients, and the trends of this performance over time. IP Law firm analytics are offered to identify performance and service opportunities for the firm, ultimately resulting in higher revenues. The Law Firm Analytics provided by Ocean Tomo (OT) equip firms with actionable data from which to make ongoing decisions. IP law firms currently have few, if any, options for conducting performance and trend analysis on themselves, the attorneys within the firm, and the breakdown of performance of the firm's clients' activities. This is a full and customizable, continuing review of a law firm, or number of law firms based on their intellectual property law firm activity, prosecution, success, clients, technology, geography and other factors. It may include some or all of the following: analytic data on the law firm, its performance, attorneys, trends, and clients, among other points of data. In certain embodiments, this is a subscription based product which will change monthly or quarterly so firms are able to identify key changes as they occur. Preferably, this information is placed in the hands of the firm as quickly as possible so they may act on this data, and either take action to correct negative results or capitalize on positive ones. Law Firm Analytics is broken down into three categories: 1) Law Firm; 2) Individual Attorneys; 3) Client Breakdown. A comparison of a law firms' analytics data and trends will fall within the Ocean Tomo Law Firm Ranking product. The purposes of LFA include the following:
Increase in Client Revenues (by identifying other client business)
Identification of prospective clients matching firm technical expertise
Identification of underperforming personnel
Identification of firm weaknesses
Improved Client Service
Improved Internal Process Management

The analytics capabilities included within this subscription may include the following:

a. The Law Firm

b. Quality of Patents Awarded—OTPR will rate every intellectual property law firm prosecuted in a particular period of time and break this down by law firm. It will then determine the average IPQ (this is the OTPR rating) score for all the intellectual property law firms awarded to that firm. This will also be broken down by specific types of claims or areas of technology.

c. Success Rate—This will be a ranking of law firms by their level of success in getting intellectual property law firms issued. Success rate will have many subcategories:

i. Success rate can be delivered to include all classes sub-classes
ii. Can be broken down by area of technology
iii. Broken down by city or state—as firms typically compete with other local or regional firms for business, the success rate can be broken down by geographic region
ix. Other breakdowns

d. Total Numbers—Issued or Pending Patents
a. Broken down by year
b. By class
c. By geography

Average Churn Rate—This metric measures the turnover and attrition of attorneys within a law firm.

Breakdown of size and focus of specific IP 2roups—This provides a snapshot of the areas of focus and expertise within a particular IP Law firm, and the amount of resources and experience within each firm's practice.

Average Pendency of Patents—This calculates the average time the firm takes from application to issuance. It can be broken down by industry or classification.

Percentage of Abandonment—Upon getting intellectual property law firms issued, this identifies the percentage of issued intellectual property law firms prosecuted by the firm which have been ultimately abandoned. This can also be broken down by classification, industry, geography.

Probability of Abandonment/Obsolescence—This will provide a statistical issued intellectual property law firms of that firm will be abandoned or become obsolete. Armed with this data at the early stages, the firms can take whatever appropriate steps are necessary, whether it be enhancing those intellectual property law firms, filling more intellectual property law firms around them to strengthen a portfolio, or commit no further resources to them. In addition, the firm could also receive a full breakdown of the probability of abandonment/obsolescence for a client's entire intellectual property law firm portfolio, including the intellectual property law firms they did not prosecute. From a competitive standpoint, firms would know which client's intellectual property law firms need attention or focus, and could focus their marketing resources accordingly.

Average life of intellectual property law firms—This delivers the actual rates of abandonment or obsolescence of intellectual property law firms prosecuted by the firm.

Client to Attorney Breakdown—This shows the number of clients per attorney, the Client's success rate with that attorney, the client's success rates with other attorneys, (both inside and outside the firm), and the number of the firms top 10 intellectual property law firming clients that attorney services. (This would allow the firm to place an “Importance” weighting each attorney has—this is something OT would customize.)

Attorney average years of experience—This may be done by an algorithm that essentially translates the attorney bar number into the years of experience, by utilizing the licensing dates. It also ties into the database of the Office of Enrollment and Discipline, State Bar Associations, Martindale Hubbell and other integrated data sources. (entire working database of who is licensed to do intellectual property law firm law).

Breakdown of size and focus of specific IP groups

Breakdown of firm's top 10 intellectual property law firming clients

Breakdown of clients success rate with that firm broken down by class

Individual Attorney Review—This will deliver similar analytic metrics and data as the review and ranking of law firms. However, this will track individual attorneys and will incorporate data and performance from all their different positions. All of the following metrics can be further broken down by classification or geography.

Breakdown of each attorney—This may include the intellectual property law firms they have prosecuted, the results of those intellectual property law firms and some or all of the other metrics contained above.

Success Rate—intellectual property law firms issued versus number applied for.

IPO Score per attorney—This is the OTPR rating for an intellectual property law firm.

By Wordiness—Based on a Word Rules Engine customized by OTPR, this would determine the over or under use of words in claim drafting.

Total number of issued intellectual property law firms per attorney

Breakdown of client's success rate with attorney

Average Pendency of Patents—which attorneys are getting intellectual property law firms issued the quickest

Average Pendency by Industry or Class—which attorneys are getting intellectual property law firms issued the quickest in particular classes.

Rates of Abandonment of issued intellectual property law firms.

Rate of Abandonment by class.

A vera2e life of intellectual property law firms-obsolescence/abandonment.

OTPR Client Analyzer—This is a product which enables a full provisioned breakdown of a firm's clients, their intellectual property law firming activity, intellectual property law firming performance, scope of representation, success rates with firm, success rates with individual attorneys, areas of opportunity, and a variety of other actionable customer analytic data for the firm. Firms can view a full comparison of their own performance versus that of other firms. This would be a subscription based product so the firm would receive monthly or bimonthly changes, or be able to search on demand for client performance and analytics.

Client Success—Utilizing the capabilities of the OTPR system, a firm could view the success breakdown of their clients both inside and outside the firm.

Inside the Firm—This provide a breakdown of a client's success rate within the firm. This includes, but is not limited to, their issuance success rate, success rate by classification and success rate broken down by individual attorney. This can also be compared to that client's performance and success rate with their other outside and inside representation. (Companies constantly weigh the pros and cons of internal versus external representation. If firms can show they are better served externally, they can use this data to gain more of that company's IP business.) This client comparison could also be done for some or all of the other analytic metrics enclosed here-in, or other obvious extensions of those metrics.

Outside the firm—This platform would deliver a full breakdown of client issuance success rates (and overall performance including all other metrics described herein) in comparison to outside firms. It would demonstrate, side by side, the performance, success rates and other metrics versus other firms competing for that same business. This analysis would break down all of the clients other IP legal representation, identify them, and deliver a comparison of not only issuance success rates, but some or all of the other relevant metrics described herein, capable of being delivered by the OTPR platform, or other obvious extensions.

Average Pendency—This determines the average amount of time it takes for a firm client's intellectual property law firms to issue beginning from the application date. This can also be broken down by classification, geography, industry, or other factors.

Law Firm Client Analysis—Breakdown of firm's top 10 intellectual property law firming clients—Through tracking the intellectual property law firms of a particular firm, and incorporating OTPR's name unification and subsidiary analysis capabilities, they system will generate the identification of a law firm's top ten (or a higher number) of the firm's most active intellectual property law firming clients.

Other Top Tens—This will also identify other firms top ten most active intellectual property law firming clients broken down by geography, industry, and other measurements and metrics described herein. In addition, this will break down to the extent possible, the most active attorneys servicing those clients within these top ten lists.

Client Activity Identifier—Along with this identification, this component would deliver the activity of those clients (within the entire intellectual property law firm space) so the firm is able to identify the amount of the client's business they are receiving. This would allow firms to identify their existing clients where there is significant opportunity for more potential work.

Overall Client Performance Breakdown—This is a breakdown of a client's success rate with that firm. Law firms may want to track the clients they represent, as well as track the IP performance of those clients to identify areas of opportunity or improvement. These metrics would be used by the firm to identify client opportunities, compare their performance to that of other firms, recognize areas of needed improvement, address personnel performance issues, and as a marketing and sales tool for new and additional business.

Breakdowns—All of the data and metrics determined above in sections 1 (a)-(c) can be broken down by many factors. This includes breaking down the metrics by classification, geography or area of technology. For individual firms, the breakdown includes identifying data by practice group, client, attorney, or even an analysis which includes the performance of partners vs. associates.

Trends—The OT LFA platform enables customers to track all of the available data metrics described herein for law firms, attorneys and clients over various periods of time. In addition, the description of the capabilities for each of these three groups is not all inclusive, and the available metrics apply and can be used for purposes of trending and comparing the three categories: firms, attorneys, and clients. For all three, it may be useful to track the changing metrics over time and recognize the increase or decrease in their parameters. These trends include the tracking of virtually any metric calculated by the LFA platform. It would include the analytics on the law firms, individual attorneys and clients.

Monitoring Capabilities—This is an ongoing monitoring service which will notify its subscribers of any changes based upon their areas of focus, law firm, attorneys, or clients, and the level of change within that focus.

Upon signing up for the OT analytics platform, law firms or third-parties will have the ability to customize their desire for particular data. Once they select what they are seeking to track, albeit law firms, individual attorneys, or particular clients, they will be able to provision exactly the type of ongoing information they are seeking, methods for filtering that information, and the frequency of receiving regular updates.

Alerts—Firms can set their own parameters not only regarding searches, but in receiving alerts when their firm's performance falls below particular levels. This would be a monthly subscription product which would be an additional add on service from a firm's subscription.

Law Firm Comparison Platform—The data generated through the Law Firm Analytics platform enables a law firm to assess its own performance, that of its attorneys, and that of its clients. While it is critical for a firm to assess its own performance, it is equally if not more critical for firms to gauge their performance against that of their competition. In their effort to attain new client business, firms need the ability to distinguish themselves from the competition and the ability to focus their energy on areas where they know they are beating other firms. This may include the ability and knowledge to track competitive activity, highlight their own strengths versus the competition and track industry and competitive trends. The LFCP enables either a firm, or third party seeking data on law firm, to view themselves and their performance side by side against other firms.

Since the data at issue remains extremely time sensitive, firms will receive regular (monthly, or more often if necessary) updates on their identified tracking targets. Firms will be able to select from a group of firms or geographic region for purposes of tracking activity and performance. They will also be able to provision the type or levels of activity that will warrant ongoing notification. For example, a firm could track when intellectual property law firm filings of a shared client increase beyond a certain percentage, when particular attorneys have changed firms, or when there is a significant decrease in that firms intellectual property law firm filings for a particular market or classification.

This platform includes the ability to rank any and all capabilities contained within the Law Firm Analytics platform under any of the following categories:

a. Law Firms

b. Individual Attorneys

c. Clients

Legal Rankings—This is a ranking of law firms based on their volume of issued intellectual property law firms, success rates, success rates by class, success within a geographic peer group, and other various criteria. This would be purchased by both law firms and third parties who need data on the legal industry and the ability to triage performance in that industry. This would be part of a regular subscription. Its usage will satisfy real-time needs for attorney and firm identification. For example, if a customer seeks to have the most successful IP firm in Seattle, with a specialty in Medical Devices and an above 80% issuance rate, this tool would allow them to find such information. Rankings would also be used as a marketing tool by firms to publicize their relative strengths to one another. The firms will also use the comparison platform to track the IP performance and metrics of their closest competitors in relation to their own.

Patent Impairment Database (“Title Impairment Database or Unified Title Clearance Product”)—Currently, there is no existing product on the market which simplifies the process of identifying all of the different mechanisms under which an intellectual property law firm is impaired. Any legal or contractual interests affecting ownership of one or more intellectual property law firms or exclusive rights granted under one or more intellectual property law firms (including assignments, security/collateral agreements, and exclusive licenses) need to be recorded at the U.S. Patent Office in order to “perfect” the interest. Failure to perfect the interest can result in loss of the interest in the event of a bankruptcy event or if the intellectual property law firm interest is for some reason later conveyed to someone else who pays valuable consideration for it. The applicable code section is 35 USC 261. The requirement also applies to original assignments from inventors (who are by default the original legal owners). Thus, a perfected chain of legal title to any intellectual property law firm interest can, in theory, be traced through official documents recorded at the USPTO. In practice, however, there are many “imperfect” intellectual property law firm interests out there. Often, an intellectual property law firm interest holder will fail to record an interest due to lack of specialized knowledge or simple oversight. In some cases, a would-be intellectual property law firm assignee may fail to secure and record properly executed assignments from each inventor listed on an intellectual property law firm. This may result in the unintended consequence of one or more original inventors retaining full or partial ownership of the intellectual property law firm. This is even though the intended assignee may be listed on the issued intellectual property law firm as the “assignee”! Not surprisingly, these kinds of problems usually surface at the most inopportune time (e.g., bankruptcy, IPO's, mergers, acquisitions, etc.) where they can really wreak havoc. Searching for and fixing intellectual property law firm title defects is an intractably time-consuming and expensive process unless one has the right database and the right people who know how to identify and fix the problems. Recording of security interests in intellectual property law firms pledged as collateral can be particularly problematic. Not only is there the basic concern of possible title defects as outlined above, but there are additional concerns to address such as ensuring timely payment of maintenance fees on the intellectual property law firm(s) and securing security interests in any continuing or related intellectual property law firms (U.S. and/or international) that may later issue. In some cases, this requires a continual monitoring effort by the secured creditor.

This is a database to determine where to go to find out if an intellectual property law firm is impaired in any fashion. These impairments include but are not limited to:
a. Abandonment—Where one can go into a database and find out whether an intellectual property law firm is abandoned—one can find this out one intellectual property law firm at a time.
b. Encumbrances—Determine if a party is holding a security interest in one's intellectual property law firm. There is no existing database for this.
c. Time to expiration
d. Validity Status—Has the intellectual property law firm ever been determined to be invalid?
e. Litigation History—Whether it was part of a litigation.
   1. Date of litigation
   2. Parties involved
   3. Settlement Result—if available

Patent Lis Pendens—Determine if an intellectual property law firm is the subject of litigation. This includes whether:

a. Owner of an intellectual property law firm claims infringement and brings an enforcement action.

b. Owner of an intellectual property law firm is sued a there is a claim that person's intellectual property law firm is infringing.

Invalidity Notification Service—This is a notification service providing regular notice of invalidated intellectual property law firms, or actions or activities which have the potential to lead to invalidation. Users can provision who they would like to track, whether it be firms, attorney, particular industries, individual clients, classification codes, etc. The service would answer the following:

a. Is the intellectual property law firm involved in litigation?

b. Was it litigated in the past?

c. Allow the user to enter certain companies and track those companies' intellectual property law firms to identify when they become invalid or involved in litigation.

Patent Index—There is currently no simple method for specifying the column/line location of particular words within an intellectual property law firm. OTPR will create a unique intellectual property law firm index for an intellectual property law firm. This automatically generated index breaks down all the words in the claims and the intellectual property law firm disclosure and identifies the corresponding location of those words within the intellectual property law firm. This is a tool for quickly identifying and locating specific intellectual property law firm information. This would be sold as a subscription where the end user would receive a fixed number of Patent Index's per month.

Automated Subject Matter Conflict Checker—This tool is would be incorporated into a law firm's existing conflict software platform to enables an automated search and identification of existing and developing IP conflicts between a law firm's clients. The system will utilize a combination of the OTPR relevance engine, name unification platform and firm data to identify potential conflicts.

The various data elements discussed herein may be obtained through public and possibly private databases. For example, some of the data may be obtained through the USPTO website or any other accessible database. Some databases may require an agreement with entities or individuals responsible for or associated with the database. Furthermore, some information may be obtained through the databases, document systems, and/or time billing records maintained by law firms. Queries can be designed and applied to access the desired data from any of the databases from which data is desired.

In some embodiments, it is contemplated that some or all of the steps described herein may be implemented within, or using, software modules (programs) that are executed by one or more general purpose computers. In these embodiments, the software modules may be stored on or within any suitable computer-readable medium. It should be understood that the various steps may alternatively be implemented in-whole or in-part within specially designed hardware. In some embodiments, the methods described herein can be implemented using a system similar to that described in U.S. Pat. No. 6,556,992 issued to Barney et al on Apr. 29,2003 (“'992 Patent”) and/or U.S. patent application Ser. No. 2004/0010393 published on Jan. 15, 2004 on behalf of Barney (“'393 Application”), which are attached hereto as part of the appendix. The '992 Patent and ′393 Application are herein incorporated by reference in their entirety and are made a part of this disclosure.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

What is claimed is:

1. A computer-automated method for rating or ranking intellectual property law firms or other intangible assets comprising:
selecting a first population of intellectual property law firms having a first quality or characteristic;
selecting a second population of intellectual property law firms having a second quality or characteristic that is different from or assumed to be different from said first quality or characteristic;
providing a computer-accessible database of selected intellectual property law firm metrics representative of or describing particular corresponding characteristics of each said intellectual property law firm in said first and second intellectual property law firm populations;
constructing a computer regression model based on said selected intellectual property law firm metrics, said regression model being operable to input said selected intellectual property law firm metrics for each said intellectual property law firm in said first and second intellectual property law firm populations and to output a corresponding rating or ranking that is generally predictive of the presence or absence of said first and/or second quality in said first and second intellectual property law firm populations according to a determined statistical accuracy; and
using said regression model to rate or rank one or more intellectual property law firms in a third intellectual property law firm population by inputting into said regression model selected intellectual property law firm metrics representative of or describing corresponding characteristics of said one or more intellectual property law firms in said third population to be rated or ranked and causing said regression model to output a corresponding rating or ranking based thereon.
